(19) United States
(12) Patent Application Publication
(10) Pub. No.: US 2024/0412072 A1
(43) Pub. Date: Dec. 12, 2024

(54) NEURAL POPULATION LEARNING

(71) Applicant: DeepMind Technologies Limited, London (GB)

(72) Inventors: Siqi Liu, London (GB); Luke Christopher Marris, London (GB); Nicolas Manfred Otto Heess, London (GB); Marc Lanctot, London (GB)

(21) Appl. No.: 18/422,620

(22) Filed: Jan. 25, 2024

Related U.S. Application Data
(60) Provisional application No. 63/481,778, filed on Jan. 26, 2023.

(51) Int. Cl. G06N 3/092

(52) U.S. Cl. CPC G06N 3/092

(57) ABSTRACT

Methods, systems, and apparatus, including computer programs encoded on a computer storage medium, for controlling an agent interacting with an environment using a population of action selection policies that are jointly represented by a population action selection neural network. In one aspect, a method comprises, at each of a plurality of time steps: obtaining an observation characterizing a current state of the environment at the time step; selecting a target action selection policy from the population of action selection policies; processing a network input comprising: (i) the observation, and (ii) a strategy embedding representing the target action selection policy, using the population action selection neural network to generate an action selection output; and selecting an action to be performed by the agent at the time step using the action selection output.

### CROSS-REFERENCE TO RELATED APPLICATION

This application claims priority to U.S. Provisional Application No. 63/481,778, filed on Jan. 26, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that can control an agent interacting with an environment using a population of action selection policies, e.g., to cause the agent to accomplish one or more tasks.

Throughout this specification, an “embedding” can refer to an ordered collection of numerical values, e.g., a vector, matrix, or other tensor of numerical values.

According to a first aspect, there is provided a method performed by one or more computers, that includes controlling an agent interacting with an environment using a population of action selection policies that are jointly represented by a population action selection neural network. At each of a plurality of time steps, controlling the agent using the population of action selection policies includes: obtaining an observation characterizing a current state of the environment at the time step; selecting a target action selection policy from the population of action selection policies; processing a network input comprising: (i) the observation, and (ii) a strategy embedding representing the target action selection policy, using the population action selection neural network to generate an action selection output; and selecting an action to be performed by the agent at the time step using the action selection output.

In some implementations, the agent is one agent in a collection of agents, the population of action selection policies includes, for each agent in the collection of agents, a set of action selection policies for the agent that each define a respective policy for selecting actions to be performed by the agent to interact with the environment, and the population action selection neural network has been trained over a plurality of update iterations. At each of the update iterations, the operations for training the population action selection neural network can include: determining a set of payoff values, with each payoff value characterizing a return received as a result of controlling each agent using a respective action selection policy for the agent; processing the set of payoff values to generate a probability distribution over a strategy assignment space, with each point in the strategy assignment space representing an assignment of a respective action selection policy to each agent in the collection of agents; and training the population action selection neural network based on the probability distribution over the strategy assignment space.

In some implementations, training the population action selection neural network based on the probability distribution over the strategy assignment space includes, for a target agent: selecting one or more points from the strategy assignment space using the probability distribution over the strategy assignment space; generating an aggregate strategy assignment embedding of the points selected from the strategy assignment space; generating a plurality of trajectories representing interaction of the collection of agents with the environment as the target agent is controlled by an action selection policy associated with the aggregate strategy assignment embedding; and training the population action selection neural network based on the plurality of trajectories.

In some implementations, selecting one or more points from the strategy assignment space using the probability distribution over the strategy assignment space includes selecting one or more points in the strategy assignment space having highest probabilities under the probability distribution over the strategy assignment space.

In some implementations, selecting one or more points from the strategy assignment space using the probability distribution over the strategy assignment space includes sampling one or more points from the strategy assignment space in accordance with the probability distribution over the strategy assignment space.

In some implementations, generating the aggregate strategy assignment embedding of the points selected from the strategy assignment space includes: determining, for each of the points selected from the strategy assignment space, a respective strategy assignment embedding for the point based on the respective strategy embedding of each action selection policy specified by the point in the strategy assignment space other than the action selection policy specified for the target agent; and generating the aggregate strategy assignment embedding based on the respective strategy assignment embedding for each of the points selected from the strategy assignment space.

In some implementations, generating the aggregate strategy assignment embedding based on the respective strategy assignment embedding for each of the points selected from the strategy assignment space includes generating the aggregate strategy assignment embedding as a linear combination of the respective strategy assignment embedding for each of the points selected from the strategy assignment space such that, for each of the points selected from the strategy assignment space, the strategy assignment embedding for the point is scaled by a probability of the point under the probability distribution over the strategy assignment space.

In some implementations, the action selection policy associated with the aggregate strategy assignment embedding is implemented by a best response action selection neural network that is conditioned on the aggregate strategy assignment embedding.

In some implementations, the best response action selection neural network is configured to, when conditioned on the aggregate strategy assignment embedding: receive an observation characterizing a state of the environment; and process the observation and the aggregate strategy assignment embedding, in accordance with values of a set of neural network parameters, to generate an action selection output that characterizes an action to be performed by a corresponding agent in response to the observation.

In some implementations, training the population action selection neural network based on the plurality of trajectories includes: conditioning the best response action selection neural network on the aggregate strategy assignment embedding; training the best response action selection neural network on the plurality of trajectories using a reinforcement learning technique; and training the population action selection neural network using the best response action selection neural network.

In some implementations, training the population action selection neural network using the best response action selection neural network includes: conditioning the population action selection neural network on a strategy embedding corresponding to an action selection policy of the target agent; and training the population action selection neural network to optimize a distillation loss that measures an error between: (i) action selection outputs generated by the population action selection neural network, and (ii) action selection outputs generated by the best response action selection neural network.

In some implementations, training the population action selection neural network to optimize the distillation loss further includes: training the strategy embedding corresponding to the action selection policy of the target agent, comprising backpropagating gradients of the distillation loss through the population action selection neural network and into the strategy embedding corresponding to the action selection policy of the target agent.

In some implementations, generating the plurality of trajectories representing interaction of the collection of agents with the environment as the target agent is controlled by the action selection policy associated with the aggregate strategy assignment embedding includes controlling each agent other than the target agent using the population action selection neural network.

In some implementations, training the population action selection neural network based on the plurality of trajectories further includes training the population action selection neural network to optimize a regularization loss that measures an error between (i) action selection outputs generated by the population action selection neural network by processing observations from the trajectories, and (ii) action selection outputs generated by a baseline population action selection neural network by processing observations from the trajectories. The baseline population action selection neural network can be a static, lagging copy of the population action selection neural network.

In some implementations, determining the set of payoff values includes, for each payoff value, processing an input that identifies a respective action selection policy for each agent in the collection of agents using a payoff prediction model to generate a predicted return that is predicted to result from controlling each agent using the corresponding action selection policy.

In some implementations, the method further includes determining that a termination criterion for the update iteration is not satisfied by: determining, for each of multiple strategy assignments, a delta between: (i) a current payoff value for the strategy assignment, and (ii) a previous payoff value for the strategy assignment, wherein each strategy assignment assigns a respective action selection policy to each agent in the collection of agents; determining that the termination criterion for the update iteration is not satisfied based on the deltas; and, in response, further training the population action selection neural network before starting a next update iteration.

In some implementations, the population action selection neural network has been trained by operations including, at each of a plurality of update iterations: determining, for each action selection policy in the population of action selection policies, a corresponding probability distribution over the population of action selection policies; generating a plurality of trajectories that each represent interaction of a pair of agents with the environment as: (i) a first agent of the pair of agents is controlled using a first action selection policy, and (ii) a second agent of the pair of agents is controlled using a second action selection policy sampled from the probability distribution corresponding to the first action selection policy; and training the population action selection neural network based on the plurality of trajectories.

In some implementations, the method further includes, at one or more of the plurality of update iterations, determining, for each action selection policy, a corresponding probability distribution over the population of action selection policies by: determining a plurality of payoff values, wherein each payoff value corresponds to a respective pair of action selection policies comprising a first action selection policy and a second action selection policy and characterizes a return achieved by controlling a first agent using the first action selection policy while a second agent is controlled using the second action selection policy; and determining the probability distributions corresponding to the action selection policies based on the plurality of payoff values.

In some implementations, the probability distributions corresponding to the action selection policies define an equilibrium-based solution of a game, such that the game is defined by the payoff values of the pairs of action selection policies.

In some implementations, the game includes a first player that selects an action selection policy for controlling the first agent and a second player selects an action selection policy for controlling the second agent.

In some implementations, the equilibrium-based solution of the game is a Nash equilibrium solution of the game.

In some implementations, the equilibrium-based solution of the game is a correlated equilibrium solution of the game.

In some implementations, the equilibrium-based solution of the game is a coarse-correlated equilibrium solution of the game.

In some implementations, determining the plurality of payoff values includes, for each payoff value: generating one or more trajectories characterizing interaction of the first agent and the second agent with the environment by controlling the first agent using the first action selection policy and controlling the second agent using the second action selection policy.

In some implementations, determining the plurality of payoff values includes, for each payoff value: processing an input that identifies the pair of action selection policies corresponding payoff value using a payoff prediction model to generate a predicted return that is predicted to result from controlling the first agent using the first action selection policy corresponding to the payoff value and controlling the second agent using the second action selection policy corresponding to the payoff value.

In some implementations, for each payoff value, the payoff prediction model is trained to minimize an expectation, over a state visitation distribution of the corresponding pair of action selection policies, of an error between: (i) a predicted payoff value for the corresponding pair of action selection policies, and (ii) state values for states of the environment when the first agent is controlled using the first action selection policy and the second agent is controlled using the second action selection policy.

In some implementations, determining, for each action selection policy, the corresponding probability distribution over the population of action selection policies includes: obtaining, for each action selection policy, a predefined probability distribution over the population of action selection policies.

In some implementations, training the population action selection neural network based on the plurality of trajectories includes training the population action selection neural network on the plurality of trajectories using a reinforcement learning technique that depends on rewards received during the interactions characterized by the trajectories.

In some implementations, training the population action selection neural network further includes backpropagating gradients through the population action selection neural network and into strategy embeddings representing the action selection policies.

In some implementations, at each of one or more time steps of the plurality of time steps, selecting the target action selection policy from the population of action selection policies includes: processing the observation using a projection neural network to generate a score distribution over the population of action selection policies; and selecting the target action selection policy in accordance with the score distribution.

According to another aspect, there is a provided a system that includes one or more computers; and one or more storage devices communicatively coupled to the one or more computers, with the one or more storage devices storing instructions that, when executed by the one or more computers, cause the one or more computers to perform the operations of the previously described method.

According to another aspect, there is provided one or more non-transitory computer storage media storing instructions that when executed by one or more computers cause the one or more computers to perform the operations of the previously described method.

Particular embodiments of the subject matter described in this specification can be implemented so as to realize one or more of the following advantages.

Interacting with an environment to accomplish a task can require an agent to leverage multiple distinct action selection strategies, e.g., at different stages of the task. However, many conventional reinforcement learning techniques learn only a single action selection policy, which may be inadequate for accomplishing difficult or complex tasks. Applying conventional reinforcement learning techniques to learn a population of action selection policies can result in a homogeneous population of action selection policies that encode similar strategies and provide little value beyond using a single action selection policy. As an example, certain tasks, such as games with multiple players and possible strategies, can require finding heterogeneous equilibria among the population of action selection policies in order to determine effective action selection policies.

To address this issue, the system described in this specification can learn a population of diverse action selection policies that are jointly represented by a single neural network, referred to for convenience as a population action selection neural network. More specifically, each action selection policy is associated with a respective embedding, referred to for convenience as a strategy embedding. Conditioning the population action selection neural network on a strategy embedding causes the population action selection neural network to implement the action selection policy corresponding to the strategy embedding. Jointly representing the population of action selection policies using a single neural network enables cross-policy transfer learning during training of the action selection neural network, e.g., as skills implicitly transfer between action selection policies. Cross-policy transfer learning can improve the performance of the population of action selection policies, and can allow the population of action selection policies to be trained using less training data than would otherwise be required, thus reducing consumption of computational resources (e.g., memory and computing power) during training as compared to training a separate independent policy network for each of the population of action selection policies.

Moreover, the system can encourage the population of action selection policies to encode diverse action selection strategies by training the population of action selection policies through self-play. More specifically, the system can simultaneously control sets of agents using the population of action selection policies, and evaluate payoffs based on returns resulting from the interactions of the agents. The payoffs characterize mutual interactions between multiple policies in the population of action selection policies (as opposed to, e.g., characterizing each action selection policy in isolation from the others), and the system can leverage the payoffs to learn complementary action selection policies (e.g., that encode diverse and synergistic strategies for accomplishing tasks).

Another issue that can arise during learning of a population of action selection policies is catastrophic forgetting, e.g., where strategies encoded in one or more of the action selection policies are gradually or abruptly erased from the action selection policies during training. The impact of catastrophic forgetting may be particularly acute when a population of action selection policies is represented in a single neural network, because training the neural network can have the effect of simultaneously adjusting all of the population of policies.

To address this issue, the system can maintain and use multiple additional neural networks during training, e.g.: (1) a best response action selection neural network, and (2) a baseline population action selection neural network. The system can train the best response action selection neural network to learn new action selection policies, e.g., by reinforcement learning, and then distill the new action selection policies from the best response action selection neural network into the population action selection neural network. In conjunction with the distillation, the system can regularize the population action selection neural network, e.g., by penalizing deviation of the population action selection neural network from the baseline population action selection neural network, which is a static and lagged copy of the population action selection neural network. Training the population action selection neural network to learn new action selection policies through distillation and regularization can reduce the likelihood of catastrophic forgetting, and thus improve the performance of the population of action selection policies and enable faster and more efficient training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates using a population action selection system to control an agent interacting with an environment.

FIG. 2 is a block diagram of an example action selection neural network.

FIG. 3 is a flow diagram of an example process for controlling an agent using a population action selection system.

FIG. 4 illustrates using a population action selection system to control multiple agents.

FIG. 5 illustrates training a population action selection system to control multiple agents.

FIG. 6 is a flow diagram of an example process for training a population action selection system.

FIG. 7 is a flow diagram of an example process for training a population action selection system with a particular target agent of an agent population using a probability distribution over a strategy assignment space.

FIG. 8 is a flow diagram of an example process for training a population action selection system based on interactions between pairs of agents.

Like reference numbers and designations in the various drawings indicate like elements.

### DETAILED DESCRIPTION

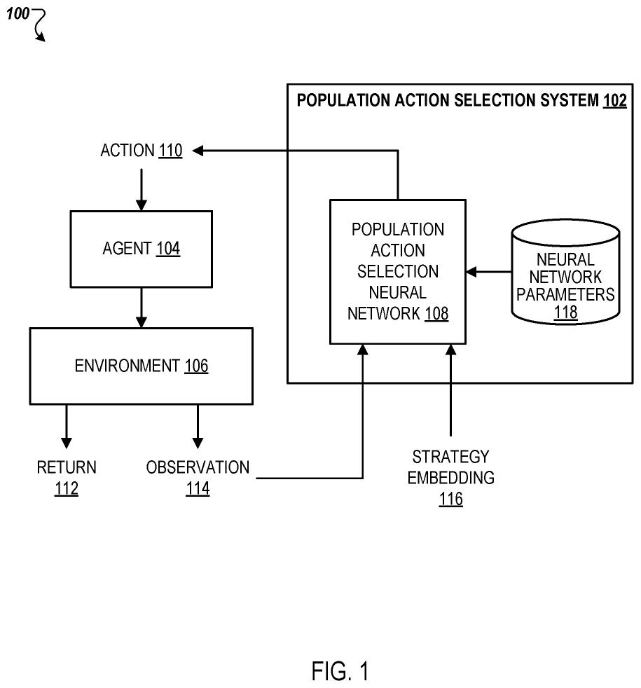

FIG. 1 illustrates using an example population action selection system 102 to control an agent 104 interacting with an environment 106. The population action selection system 102 is an example of a system implemented as computer programs on one or more computers in one or more locations in which the systems, components, and techniques described below are implemented.

The system 102 can control the agent 104 interacting with the environment 106 using a population of action selection policies, e.g., to cause the agent 104 to accomplish one or more tasks. The population of action selection policies can be a collection of multiple action selection policies. Each policy from the population of action selection policies can be a function (e.g., as determined using a trained neural network) that can process observations 114 from the environment to select actions 110 for the agent 104 to perform. The system 102 can, using a policy from the population of action selection policies, process observations 114 from the environment to select actions 110 for the agent 104 to perform. When the agent 104 performs the actions 110, the agent 104 can receive a reward or return 112 that can represent a progress of the agent 104 in performing the one or more tasks.

The system 102 includes a population action selection neural network 108 that can jointly represent the population of action selection policies. More specifically, each action selection policy can be associated with a respective strategy embedding 116, and conditioning the population action selection neural network on a strategy embedding 116 causes the population action selection neural network to implement the corresponding action selection policy.

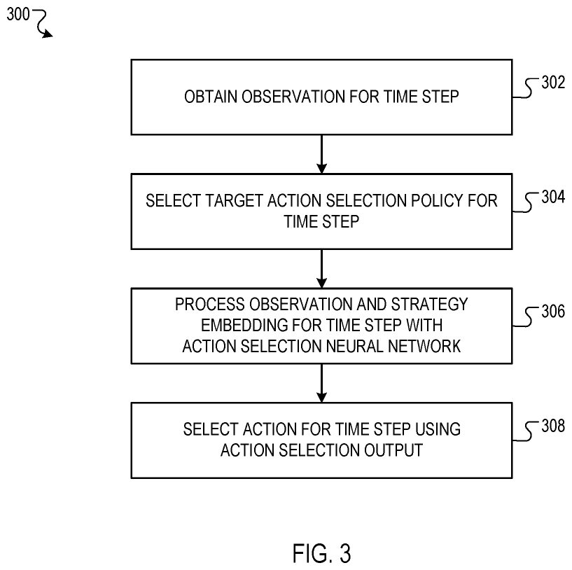

At each time step in a sequence of time steps, the system 102 can obtain an observation 114 characterizing a current state of the environment 106 at the time step. The system 102 can select a target action selection policy from the population of action selection policies, e.g., by obtaining a strategy embedding 116 representing the target action selection policy, and can process the observation 114 and the strategy embedding 116 using the population action selection neural network 108 to generate an action selection output. The system 102 can then select an action 110 to be performed by the agent 104 at the time step using the action selection output. An example process of using the system 102 to control the agent 104 is explained in more detail below with reference to FIG. 3.

In some implementations, the environment 106 is a real-world environment, the agent 104 is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent 104 may be a robot interacting with the environment 106 to accomplish a specific task, e.g., to locate an object of interest in the environment 106 or to move an object of interest to a specified location in the environment 106 or to navigate to a specified destination in the environment 106.

In these implementations, the observations 114 may include, e.g., one or more of: images, object position data, and sensor data to capture observations as the agent 104 interacts with the environment 106, for example sensor data from an image, distance, or position sensor or from an actuator. For example in the case of a robot, the observations 114 may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations 114 may be defined in 1, 2 or 3 dimensions, and may be absolute and/or relative observations. The observations 114 may also include, for example, sensed electronic signals such as motor current or a temperature signal; and/or image or video data for example from a camera or a LIDAR sensor, e.g., data from sensors of the agent or data from sensors that are located separately from the agent 104 in the environment 106.

In these implementations, the actions 110 may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment 106 the control of which has an effect on the observed state of the environment 106. For example in the case of an autonomous or semi-autonomous land or air or sea vehicle the control signals may define actions to control navigation e.g. steering, and movement e.g., braking and/or acceleration of the vehicle.

In some implementations, the environment 106 is a simulation of the above-described real-world environment, and the agent 104 is implemented by one or more computers interacting with the simulated environment. For example, the simulated environment may be a simulation of a robot or vehicle and the reinforcement learning system may be trained on the simulation and then, once trained, used in the real-world.

In some implementations the environment 106 is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent 104 may comprise an electronic agent configured to control a manufacturing unit, or a machine such as a robot, that operates to manufacture the product. That is, the agent 104 may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent 104 may comprise a task to manufacture the product or an intermediate version or component thereof. As another example, a task performed by the agent 104 may comprise a task to control, e.g., minimize, use of a resource such as a task to control electrical power consumption, or water consumption, or the consumption of any material or consumable used in the manufacturing process.

The actions 110 may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general, the actions 110 may be any actions that have an effect on the observed state of the environment 106, e.g., actions configured to adjust any of the sensed parameters described below. These may include actions to adjust the physical or chemical conditions of a manufacturing unit, or actions to control the movement of mechanical parts of a machine or joints of a robot. The actions 110 may include actions imposing operating conditions on a manufacturing unit or machine, or actions that result in changes to settings to adjust, control, or switch on or off the operation of a manufacturing unit or machine.

The rewards or return 112 may relate to a metric of performance of the task. For example, in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use of a resource the metric may comprise any metric of usage of the resource.

In general, observations 114 of a state of the environment 106 may comprise any electronic signals representing the functioning of electronic and/or mechanical items of equipment. For example, a representation of the state of the environment 106 may be derived from observations 114 made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations 114 from the sensors may include observations of position, linear or angular velocity, force, torque or acceleration, or pose of one or more parts of the machine, e.g., data characterizing the current state of the machine or robot or of an item held or processed by the machine or robot. The observations 114 may also include, for example, sensed electronic signals such as motor current or a temperature signal, or image or video data for example from a camera or a LIDAR sensor. Sensors such as these may be part of or located separately from the agent 104 in the environment 106.

In some implementations the environment 106 is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general, the actions 110 may be any actions that have an effect on the observed state of the environment 106, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general, observations 114 of a state of the environment 106 may comprise any electronic signals representing the functioning of the facility or of equipment in the facility. For example, a representation of the state of the environment 106 may be derived from observations 114 made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return 112 may relate to a metric of performance of the task. For example, in the case of a task to control, e.g., minimize, use of a resource, such as a task to control use of electrical power or water, the metric may comprise any metric of use of the resource.

In some implementations, the environment 106 is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent 104 may comprise an electronic agent configured to control the generation of electrical power by the facility or the coupling of generated electrical power into the grid. The actions 110 may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return 112 may relate to a metric of performance of the task. For example, in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general, observations 114 of a state of the environment 106 may comprise any electronic signals representing the electrical or mechanical functioning of power generation equipment in the power generation facility. For example, a representation of the state of the environment 106 may be derived from observations 114 made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations 114 of a state of the environment 106 may also comprise one or more predictions regarding future conditions of operation of the power generation equipment such as predictions of future wind levels or solar irradiance or predictions of a future electrical condition of the grid.

As another example, the environment 106 may be a chemical synthesis or protein folding environment such that each state is a respective state of a protein chain or of one or more intermediates or precursor chemicals and the agent 104 is a computer system for determining how to fold the protein chain or synthesize the chemical. In this example, the actions 110 are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent 104 may be a mechanical agent that performs or controls the protein folding actions or chemical synthesis steps selected by the system automatically without human interaction. The observations 114 may comprise direct or indirect observations of a state of the protein or chemical/intermediates/precursors and/or may be derived from simulation.

In a similar way the environment 106 may be a drug design environment such that each state is a respective state of a potential drug and the agent 104 is a computer system for determining elements of the drug and/or a synthetic pathway for the drug. The drug/synthesis may be designed based on a reward or return 112 derived from a target for the drug, for example in simulation. As another example, the agent 104 may be a mechanical agent that performs or controls synthesis of the drug.

In some further applications, the environment 106 is a real-world environment and the agent 104 manages distribution of tasks across computing resources, e.g., on a mobile device and/or in a data center. In these implementations, the actions 110 may include assigning tasks to particular computing resources.

As further example, the actions 110 may include presenting advertisements, the observations 114 may include advertisement impressions or a click-through count or rate, and the reward or return 112 may characterize previous selections of items or content taken by one or more users.

In some cases, the observations 114 may include textual or spoken instructions provided to the agent 104 by a third-party (e.g., an operator of the agent 104). For example, the agent 104 may be an autonomous vehicle, and a user of the autonomous vehicle may provide textual or spoken instructions to the agent 104 (e.g., to navigate to a particular location).

As another example the environment 106 may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations 114 may comprise observations that characterize the entity, i.e., observations of a mechanical shape or of an electrical, mechanical, or electro-mechanical configuration of the entity, or observations of parameters or properties of the entity. The actions 110 may comprise actions that modify the entity, e.g., that modify one or more of the observations. The rewards or return 112 may comprise one or more metrics of performance of the design of the entity. For example, the rewards or returns 112 may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described, the environment 106 may be a simulated environment. Generally in the case of a simulated environment the observations 114 may include simulated versions of one or more of the previously described observations or types of observations and the actions 110 may include simulated versions of one or more of the previously described actions or types of actions. For example, the simulated environment may be a motion simulation environment, e.g., a driving simulation or a flight simulation, and the agent 104 may be a simulated vehicle navigating through the motion simulation. In these implementations, the actions 110 may be control inputs to control the simulated user or simulated vehicle. Generally the agent 104 may be implemented by one or more computers interacting with the simulated environment.

The simulated environment may be a simulation of a particular real-world environment and agent. For example, the system 102 may be used to select actions 110 in the simulated environment during training or evaluation of the system 102 and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system 102 may be partly trained using a simulation of a mechanical agent in a simulation of a particular real-world environment, and afterwards deployed to control the real mechanical agent in the particular real-world environment. Thus in such cases the observations 114 of the simulated environment relate to the real-world environment, and the selected actions 110 in the simulated environment relate to actions to be performed by the mechanical agent in the real-world environment.

Optionally, in any of the above implementations, the observation 114 at any given time step may include data from a previous time step that may be beneficial in characterizing the environment 106, e.g., the action 110 performed at the previous time step, the reward or return 112 received at the previous time step, or both.

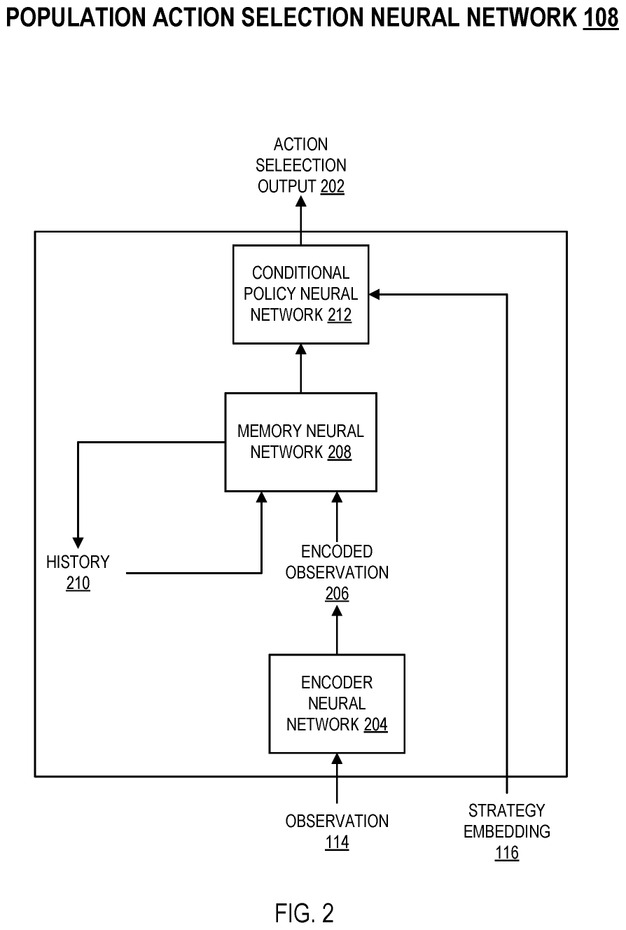

FIG. 2 is a block diagram of an example population action selection neural network 108. The population action selection neural network 108 is an example of a system implemented as computer programs on one or more computers in one or more locations in which the systems, components, and techniques described below are implemented.

As described above, the population action selection neural network 108 can jointly represent a population of action selection policies. The neural network 108 can receive and process the observation 114 and the strategy embedding 116 to generate an action selection output 202. The neural network 108 can generate the action selection output 202 based on the action selection policy corresponding to the strategy embedding 116. In particular, the neural network 108 can process the observation 114 as conditioned on the strategy embedding 116 to generate the action selection output 202 based on the action selection policy represented by the strategy embedding 116.

The population action selection neural network 108 can include an encoder neural network 204. The encoder neural network 204 can process the observation 114 to produce an encoded observation 206. The encoder neural network 204 can have any of a variety of architectures suited to processing the observation 206. For example, if the observation 206 includes image data, the encoder neural network 204 can include neural networks suited to processing images (e.g., convolutional neural networks, visual transformers, etc.). As another example, if the observation 206 includes text data, the encoder neural network 204 can include neural networks suited to processing text (e.g., text embedding networks, transformers, etc.).

The encoded observation 206 can characterizes the observation 114 by any of a variety of means. For example, the encoded observation 206 can be a representation of the observation 114 within a lower dimensional space than the observation 114, e.g., a linear or non-linear projection of the observation 114, a compression of the observation 114, and so on. As another example, the encoded observation 206 can be a tokenized representation of the observation 114 that represents the observation 114 as a set of one or more tokens. The encoded observation 206 may be the observation 114.

The population action selection neural network 108 can include a memory neural network 208. The memory neural network 208 can process the encoded observation 206 and data characterizing a history 210 of prior observations to produce a network output. The neural network 208 can have any of a variety of architectures. For example, the memory neural network 208 can have a recurrent architecture (e.g., a recurrent neural network, a long-short term memory network, etc.) and the history 210 can be a hidden state (e.g., a set of numerical values stored by the neural network 208). The neural network 208 can use the current hidden state to process the encoded observation 206 and can update the hidden state based on the encoded observation 206. As another example, the memory neural network 208 can be, e.g., a transformer, that uses attention between the encoded observation 206 and the history 210 to generate the memory neural network output. The history 210 can be a sequence of encoded observations and the memory neural network can update the history 210 by appending the current encoded observation 206 to the sequence.

The population action selection neural network 108 can include a conditional policy neural network 212. The conditional policy neural network can process the memory neural network output and the strategy embedding 116 to produce the action selection outputs 202. The conditional policy neural network 212 can jointly represent the population of action selection policies and can process the memory neural network output based on the action selection policy represented by the strategy embedding 116.

In particular, the conditional policy neural network 212 can process the memory neural network output as conditioned on the strategy embedding 116. As an example, the neural network 212 can process the strategy embedding 116 to determine a set of conditional policy neural network weights for processing the memory neural network output. As another example, the neural network 212 can process a combined input of the memory neural network output and the strategy embedding (e.g., a concatenation of the memory neural network output and the strategy embedding).

The conditional policy neural network 212 can produce any of a variety of action selection outputs 202. For example, the conditional policy neural network 212 can predict rewards or returns for a set of actions and the action selection output 202 can characterize the predicted rewards or returns. As another example, the conditional policy neural network 212 can model a conditional probability distribution of actions given the observation 114 and the strategy embedding 116 and the action selection output 202 can characterize the conditional distribution.

FIG. 3 is a flow diagram of an example process for controlling an agent using a population action selection system. For convenience, the process 300 will be described as being performed by a system of one or more computers located in one or more locations. For example, a population action selection system, e.g., the population action selection system 102 of FIG. 1, appropriately programmed in accordance with this specification, can perform the process 300.

The system can control an agent interacting with an environment using a population of action selection policies. The system can jointly represent the population of action selection policies using a population action selection neural network. The system can control the agent over a sequence of time steps.

As each time step, the system can obtain an observation for the time step that characterizes a current state of the environment at the time step (step 302). For example, the observation can include signals or data as collected by sensors for the agent. As another example, the observation can include data characterizing actions of other agents within the environment. The observations may be simulated observations of the environment.

The system can select a target action selection policy for the time step from the population of action selection policies (step 304). Each of the population of action selection policies can be represented by a corresponding strategy embedding. As part of selecting the target action selection policy for the time step, the system can obtain the strategy embedding that corresponds to the target policy. For example, the system can receive data specifying the target policy (e.g., data identifying the target policy, a strategy embedding, etc.) and can select the specified target policy and corresponding strategy embedding. As another example, the system can process the observation to select the specified target policy and corresponding strategy embedding. The system may select the same target action selection policy for every time step.

In some implementations, the system can select the target action selection policy for the time step by processing the observation for the time step using a projection neural network. The projection neural network can process the observation and generate a score distribution over the population of action selection policies. The system can select the target action selection policy in accordance with the score distribution generated by the projection neural network. As an example, the system can select the target selection policy assigned the largest score within the score distribution. As another example, the system can select the target selection policy by sampling the policy from a probability distribution determined by the score distribution.

The system can use the population action selection neural network to process a network input that includes the observation and the strategy embedding for the time step and generate an action selection output (step 306). The action selection output can characterize one or more actions that can be performed by the agent by any of a variety of means. For example, the action selection output can characterize a probability distribution over a set of actions that the agent can perform. As another example, the action selection output can characterize a predicted reward or return for each of a set of actions that the agent can perform.

The system can select an action to be performed by the agent at the time step using the action selection output (step 308). The system can use the action selection output to select the action to be performed by the agent by any of a variety of means. For example, when the action selection output characterizes a probability distribution over a set of actions, the system can select the action to be performed by the agent at the time step by sampling from the probability distribution characterized by the action selection output. As another example, when the action selection output characterizes predicted rewards or returns for each of a set of actions, the system can select the action to be performed by the agent at the time step by selecting the action characterized by the action selection output that has the largest predicted reward or return.

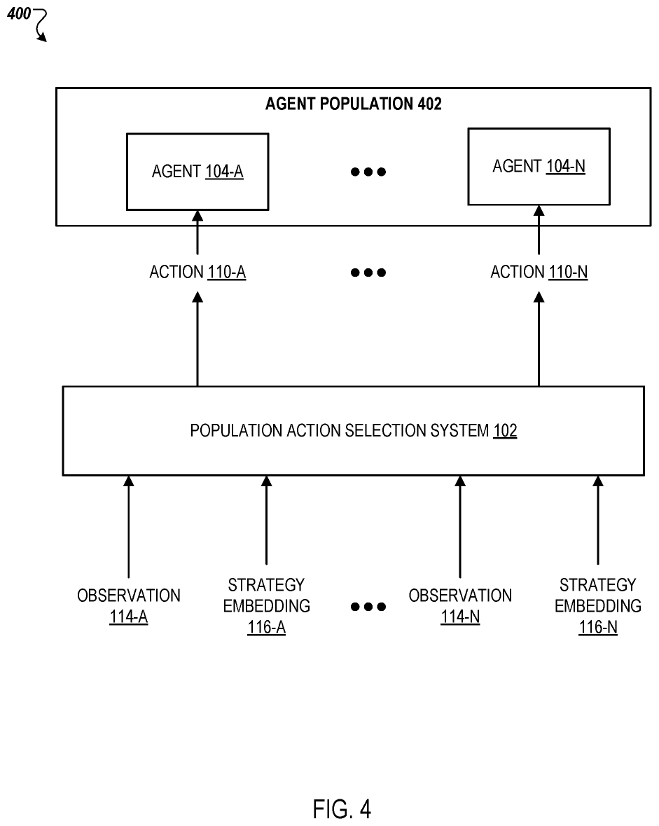

FIG. 4 illustrates using the population action selection system 102 to control multiple agents in an agent population 402. The agent population 402 includes the agents 104-A through 104-N.

For each of the agents 104-A through 104-N, the population action selection system 102 can process observations 114-A through 114-N to select an action selection policy and to select actions 110-A through 110-N for the respective agents. The system 102 can select the actions 110-A through 110-N by performing the process 300 of FIG. 3 for each of the agents 104-A through 104-N.

The population action selection system 102 can select the action selection policy for each of the agents by obtaining and processing respective strategy embeddings 116-A through 116-N. The strategy embeddings 116-A through 116-N characterize the respective selected action selection policies. In particular, the strategy embeddings 116-A through 116-N can characterize action selection policies that are specific to the respective agents 110-A through 110-N.

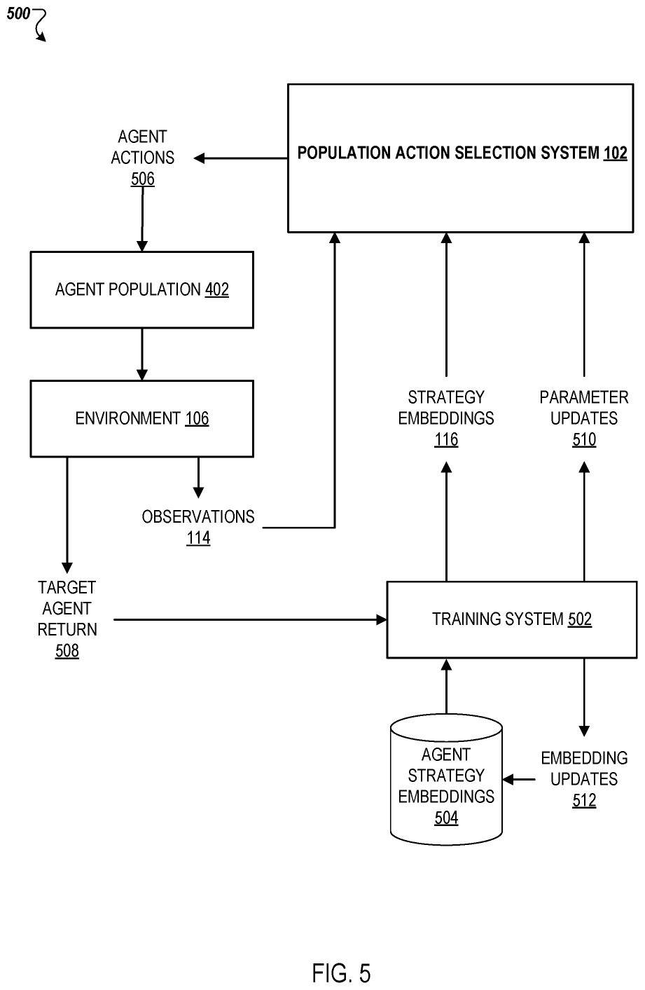

FIG. 5 illustrates using an example training system 502 to train a population action selection system 102 to control multiple agents from an agent population 402.

The training system 502 can train the population action selection system 102 over a sequence of update iterations. At each update iteration, the training system 502 can select a target agent and one or more other, non-target agents for the update iteration from the agent population 402. The training system 502 can provide strategy embeddings 116 corresponding to the selected target and non-target agents for the update iteration to the population action selection system 102. The training system 502 can select the strategy embeddings 116 from a set of agent strategy embeddings 504.

Before training the population action selection system 102, the training system 502 can initialize the set of agent strategy embeddings 504 to any appropriate initial embeddings. For example, the system 502 can initialize the embeddings 116 in the set of agent strategy embeddings 504 by randomly sampling values for the embeddings 116. As another example, the system can initialize the embeddings 116 in the set of agent strategy embeddings 504 by assigning pre-determined values for the embeddings 116.

The population action selection system 102 can process the strategy embeddings 116 and observations 114 to select agent actions 506 for the target and non-target agents for the update iteration. The target and non-target agents for the update iteration can perform the agent actions 506 and interact with the environment 106. The training system 502 can receive a return 508 for the target agent based on the target agent interacting with the environment 106 during the update iteration.

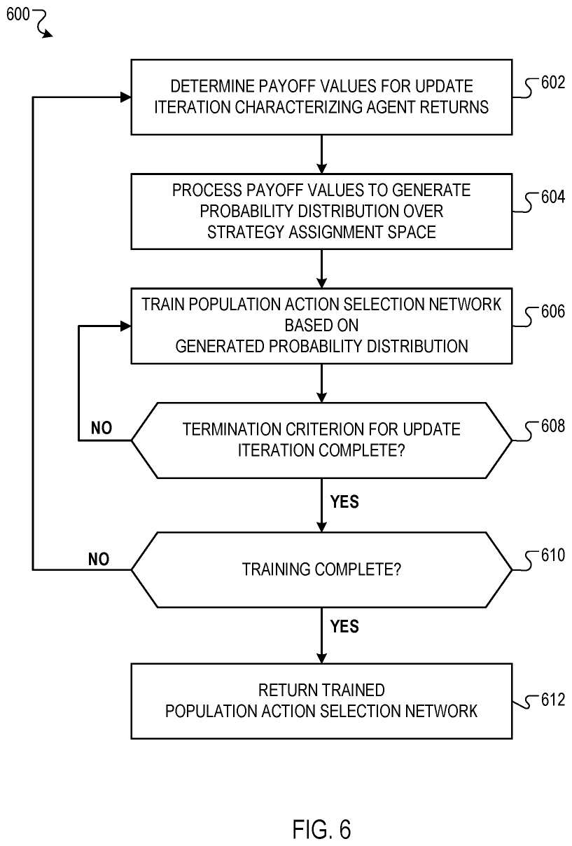

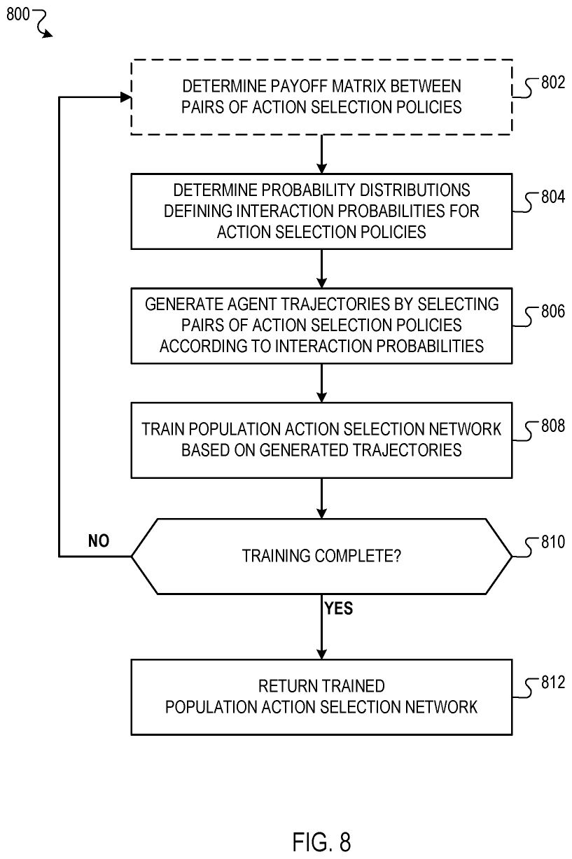

At each update iteration, the training system 502 can determine parameter updates 510 for the population action selection system 102 based on the target agent returns 510 for the update iteration. The training system 502 can determine embedding updates 512 for the agent strategy embeddings 504 based on the target agent returns 508 for the update iteration. The system 502 can determine the parameter updates 510 and embedding updates 512 by determining gradients (e.g., using backpropagation) of an objective function with respect to the neural network parameters of the system population action selection system 102 and with respect to the strategy embeddings 116. The system 502 can determine the objective function based on the target agent returns 510 for the update iteration. The system 502 can determine the parameter updates 510 and the embedding updates 512 using any appropriate gradient descent rule for the objective function (e.g., stochastic gradient descent, RMSprop, Adam, etc.). The system 502 can determine parameter updates 510 and embedding updates 512 that encourage, based on the objective function, the population of action selection policies represented by the system 102 to approach an equilibrium of the agents' tasks (e.g., a Nash equilibrium, a correlated equilibrium, a coarse correlated equilibrium, etc.). Example procedures for training the population action selection system 102 are described in more detail below with reference to FIG. 6 and FIG. 8.

FIG. 6 is a flow diagram of an example process for training a population action selection system. For convenience, the process 600 will be described as being performed by a system of one or more computers located in one or more locations. For example, a training system, e.g., the training system 502 of FIG. 5, appropriately programmed in accordance with this specification, can perform the process 600.

The training system can train the population action selection system over a sequence of update iterations. The training system can train the population action selection system to select actions for each agent within a population of agents jointly interacting with an environment to perform a respective task for each agent.

As described above, the population action selection system can select actions for a particular agent according to a particular action selection policy for the particular agent by conditionally processing a strategy embedding specific to the particular agent and action selection policy. For example, the population action selection system can select actions according to action selection policy a for agent p by conditionally processing a strategy embedding, vₚ^{a}, that is specific to the policy a for the agent p. The training system can train the population action selection system by optimizing both the neural network parameters of the population action selection system and the strategy embeddings for each of the agents in the agent population.

The training system can train the population action selection system to select actions for each agent within the agent population using a finite set of possible action selection policies for each of the agents. For example, the training system can train the population action selection system to select actions for each agent within the agent population using T action selection policies for each agent, as represented by nT strategy embeddings in total, v₁¹ . . . v₁^{T} . . . vₙ¹ . . . vₙ^{T}, where n is the number of agents within the agent population. As a further example, during the t-th update iteration, the training system can train the population action selection system to select actions for each agent within the agent population using t action selection policies for each agent, as represented by nt strategy embeddings, v₁¹ . . . v₁^{t} . . . vₙ¹ . . . vₙ^{t}. In particular, during the t-th update iteration, the training system can train the population action selection system to select actions for each agent within the agent population using t action selection policies for each agent, such that the n strategy embeddings added during the t-th update iteration, v₁^{t} . . . vₙ^{t}, represent respective best-response action selection policies for each of the agents with respect to the agent population selecting actions according to the set of n(t−1) action selection policies, v₁¹ . . . v₁^{t-1} . . . vₙ¹ . . . vₙ^{t-1}, trained during the previous update iterations.

At each update iteration, the system can determine a set of payoff values for the update iteration (step 602). Each payoff value can characterize a return received as a result of controlling each agent using a respective action selection policy for the agent. For example, when the agents are cooperatively interacting with the environment to perform a task, each payoff value can be a return jointly received by all agents as a result of the actions selected by each of the agents. As another example, when the agents are competing with one another while interacting with the environment (e.g., as part of a competitive game), each payoff value can represent separate returns received by each agent as a result of actions selected by all of the agents.

When the population action selection system can select actions for each agent within the agent population from a respective set of T action selection policies for each agent, the set of payoff values can be a set of Tⁿ payoff values, with each payoff value characterizing returns received as a result of controlling each of the n agents according to one of the respective T policies for the agent.

As an example, during the t-th update iteration, the set of payoff values can be a set of n^{t-1} payoff values determined by an expected payoff function:

$$EP ( {v}_{1} , ... , {v}_{n} )$$

Where vᵢ is a strategy embedding for the i-th agent selected from the set of embeddings, vᵢ¹ . . . vᵢ^{t-1}.

The system can determine the set of payoff values by any appropriate method. For example, the system can control the agent population using each combination of learned action selection policies for the agents to determine the set of payoff values.

As another example, in some implementations, the system can use a payoff prediction model to predict each of the set of payoff values. The payoff prediction model can process an input that identifies a respective action selection policy for each agent in the agent population using to generate a predicted return that is predicted to result from controlling each agent using the corresponding action selection policy. For example, the payoff prediction model can process sets of embedding vectors for the agents and can model the expected payoff function, EP(v₁, . . . , vₙ).

The payoff prediction model can be trained (e.g., by the system) to predict the sets of payoff values by any appropriate machine learning technique. For example, the payoff prediction model can be trained to optimize a prediction loss (e.g., mean squared error) between predictions generated by the model for example policies and target payoff values for the example policies.

The system can process the set of payoff values to generate a probability distribution over a strategy assignment space (step 604). Each point in the strategy assignment space can represent an assignment of a respective action selection policy to each agent in the collection of agents.

For example, the system can generate the probability distribution, p(a₁, . . . , aₙ), representing a probability that the agents of the agent population select actions according to the action selection policies, a₁, . . . , aₙ. As another example, at the t-th update iteration, the system can generate the probability distribution, p(v₁, . . . , vₙ), representing a probability that the agents of the agent population select actions according to the policies represented by the strategy embeddings, v₁ . . . vₙ, as selected from the set of action selection policies, v₁¹ . . . v₁^{t-1} . . . vₙ¹ . . . vₙ^{t-1}.

In particular, the system can generate the probability distribution to be a mixed-strategy ε-coarse correlated equilibrium (ε-CCE) for the payoff values. For example, the system can determine the probability distribution by processing the set of payoff values using an ε-CCE solver. As a further example, the system can determine the probability distribution using a Max-Gini ε-CCE solver as described by Marris et al. in “Multi-Agent Training Beyond Zero-Sum with Correlated Equilibrium Meta-Solvers” (2021), which optimizes a Gini coefficient determined for the agent population. As further examples, the system can determine the probability distribution using, e.g., a Max-Welfare ε-CCE solver that optimizes a welfare (e.g., a social welfare) determined for the agent population, a Max-Entropy ε-CCE solver that optimizes an overall uncertainty determined for the agent population (e.g., an uncertainty of which agent receives a largest reward for the task), and so on.

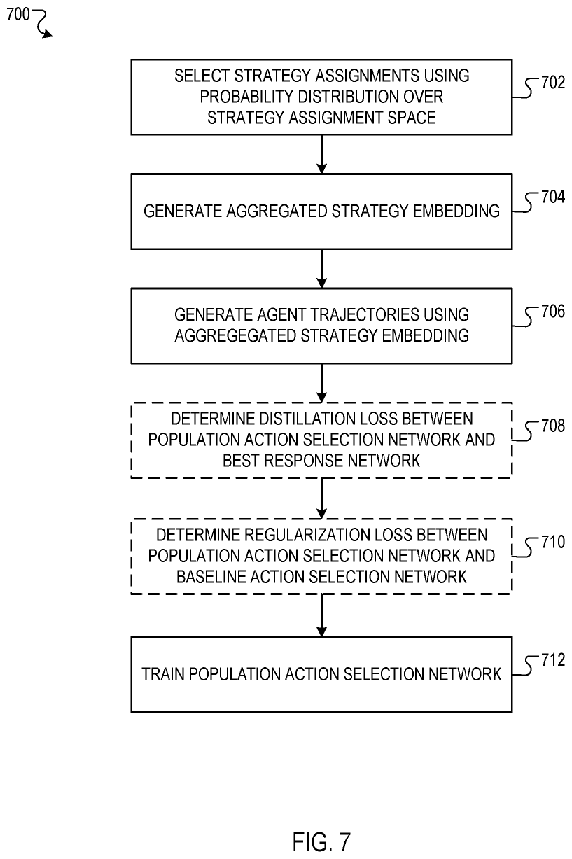

The system can train the population action selection neural network based on the probability distribution over the strategy assignment space (step 606). For each update iteration, the system can train the population action selection neural network based on the probability distribution for the update iteration over a sequence of training epochs. As part of training the population action selection neural network, the system can select a target agent to use for training. As an example, for each training epoch, the system can select a target agent to use during the training epoch. As another example, the system can cycle through using each agent of the agent population as a target agent for each training epoch. An example process for training the population action selection neural network with a particular target agent of the agent population using the probability distribution over the strategy assignment space is described in more detail below with reference to FIG. 7.

In some implementations, the system can determine whether a termination criterion for the update iteration is satisfied (step 608). If the system determines that the termination criterion for the update iteration is not satisfied, the system can continue training the population action selection neural network based on the probability distribution for the update iteration.

The system can utilize any of a variety of termination criteria for the update iteration. For example, the termination criterion can be satisfied after a pre-determined number of training epochs for the update iteration. As another example, the termination criterion can be based on deltas, determined for each of multiple strategy assignments by the system between: (i) a current payoff value for the strategy assignment, and (ii) a previous payoff value for the strategy assignment. Each strategy assignment can assign a respective action selection policy to each agent in the collection of agents. For example, the termination criterion can be satisfied when:

$${\sum }_{{a}_{1} , ... , {a}_{n}} p ( {a}_{1} , ... , {a}_{n} ) [ EP ( {v}_{1}^{{a}_{1}} , ... , {v}_{n}^{{a}_{n}} ; θ ) - EP ( {\hat{v}}_{1}^{{a}_{1}} , ... , {\hat{v}}_{n}^{{a}_{n}} ; \hat{θ} ) ] < δ$$

Where θ are the current population action selection neural network parameters, \hat{θ} are previous population action selection neural network parameters, \hat{v}ᵢ^{a}^{ᵢ} is a previous strategy embedding for policy aᵢ for the i-th agent, and δ is a pre-determined termination threshold value.

The system can determine whether the training has completed (step 610). The system can determine whether the training has completed based on any suitable criterion. For example, the system can determine that training has completed after a pre-determined number of update iterations. As another example, the system can determine that training has completed based on the set of payoff values for the update iteration. As a particular example, the system can determine that training has completed based on whether the payoff values for the update iteration attain pre-determined threshold values. As another particular example, the system can determine that training has completed based on a difference between the payoff values for the current update iteration and a previous update iteration (e.g., based on whether the difference indicates a convergence of the population action selection neural network).

If the system determines that training has not completed, the system can proceed to a next update iteration for training the population action selection neural network.

When the system determines that the training has completed, the system can return the trained population action selection neural network (step 612).

FIG. 7 is a flow diagram of an example process for training a population action selection system with a particular target agent of an agent population using a probability distribution over a strategy assignment space. For convenience, the process 700 will be described as being performed by a system of one or more computers located in one or more locations. For example, a training system, e.g., the training system 502 of FIG. 5, appropriately programmed in accordance with this specification, can perform the process 700.

The system can select a set of points from the strategy assignment space using the probability distribution over the strategy assignment space (step 702). For example, the probability distribution, p(a₁, . . . , aₙ), can represent a probability that the agents of the agent population select actions according to the action selection policies, a₁, . . . , aₙ, and the system can select points a=a₁, . . . , aₙ based on the probability distribution. As another example, the probability distribution, p(v₁, . . . , vₙ), can represent a probability that the agents of the agent population select actions according to the policies represented by the strategy embeddings, v₁ . . . vₙ and the system can select points represented by the joint embedding v=v₁ . . . vₙ.

In some implementations, the system can select the K most likely points from the probability distribution (e.g., the points a¹ . . . a^{K} having the K largest probabilities, p(a)). In some implementations, the system can sample points from the strategy assignment space according to the probability distribution (e.g., by sampling K points following a¹ . . . a^{K}˜p(a)).

The system can generate an aggregate strategy assignment embedding for the selected set in the strategy assignment space (step 704). The system can generate the aggregate strategy assignment embedding to represent a marginal strategy embedding of all the agents other than the target agent.

The system can determine a respective strategy embedding for each of the selected points in the strategy assignment space, a¹ . . . a^{K}, and can generate the aggregate strategy assignment embedding based on the strategy embeddings for the selected points. In particular, when the system selects the points a¹ . . . a^{K} by selecting joint embeddings based on the probability distribution over strategy embeddings, p(v₁ . . . vₙ), the system can generate the aggregate strategy assignment embedding based on the selected joint embeddings.

As an example, the system can generate the aggregate strategy assignment embedding as a linear combination of the respective strategy assignment embedding for each of the selected points that combines the embeddings of the selected points by probabilities of the points under the probability distribution over the strategy assignment space, p(a). For example, the system can generate the marginal strategy embedding, v_{¬i}, for the i-th agent following:

$${v}_{¬ i} = {\sum }_{j = 1}^{K} p ( {a}^{j} ) v ( {a}^{j} )$$

Where a^{j} is the j-th selected point in the strategy assignment space and v(a^{j}) is the strategy embedding for the j-th selected point in the strategy assignment space.

As a further example, when the system selects the points a¹ . . . a^{K} by selecting joint embeddings based on the probability distribution over strategy embeddings, p(v₁ . . . vₙ), the system can generate the marginal strategy embedding, v_{¬i}, for the i-th agent following:

$${v}_{¬ i} = {\sum }_{j = 1}^{K} p ( {v}_{1}^{j} , ... , {v}_{n}^{j} ) f ( {v}_{1}^{j} , ... , {v}_{i - 1}^{j} , 0 , {v}_{i + 1}^{j} , ... , {v}_{n}^{j} )$$

Where ƒ is a strategy assignment aggregation function. In particular, ƒ(v₁ . . . vₙ) can concatenate the input strategy embeddings, v₁ . . . vₙ, and the marginal strategy embedding, v_{¬i}, for the i-th agent can therefore be a concatenation of an average strategy embedding for each of the agents with the strategy embedding for the i-th agent set to zero. Namely, the marginal strategy embedding, v_{¬i}, can have the form:

$${v}_{¬ i} = ( {\overline{v}}_{1} , ... , {\overline{v}}_{i - 1} , 0 , {\overline{v}}_{i + 1} , ... , {\overline{v}}_{n} )$$

Where v̅ⱼ is an average strategy embedding for the j-th agent.

The system can generate a plurality of trajectories representing interaction of the collection of agents with the environment as the target agent is controlled by an action selection policy associated with the aggregate strategy assignment embedding (step 706). Each of the generated trajectories can be a joint trajectory that specifies observations and selected actions for each of the agents of the agent population. The system can receive respective returns or rewards for the target agent resulting from each of the generated trajectories.

As part of generating the trajectories, the system can control each agent other than the target agent using the population action selection neural network. For example, the system can process an observation for the j-th agent, oⱼ, and determine an action for the j-th agent by processing:

$${\prod }_{θ} ( {v}_{¬ i , j} )$$

Where Π_{θ} is the population action selection neural network and v_{¬i,j} is the marginal strategy embedding for the j-th agent (e.g., as above, v_{¬i,j}=v̅ⱼ).

As part of training the population action selection neural network, the system can train a best response action selection neural network. To help prevent the population action selection neural network from catastrophically forgetting previously learned policies, the system can indirectly train the population action selection network by training the best response action selection network to select actions for the target agent and then training the population action selection network to replicate the best response action selection network. The best response action selection neural network can be an updated version of the population action selection neural network, with updated network parameters as determined by training the best response action selection neural network.

The system can control the target agent using a best response action selection neural network. For example, the best response action selection neural network can receive observations for the target agent and generate an action selection network output for the target agent as conditioned on the aggregate strategy assignment embedding, v_{¬i}.

For example, when the i-th agent of the agent population is the target agent, the system can process an observation for the target agent, oᵢ, and determine an action for the target agent by processing:

$${\prod }_{ϕ} ( {v}_{i}^{*} )$$

Where Π_{ϕ} is the best response action selection neural network and v*ᵢ is a strategy embedding for the target agent.

The system can train the best response action selection neural network over a sequence of training steps using the generated trajectories. The system can use any of a variety of reinforcement learning techniques (e.g., Q-learning, policy gradients, proximal policy optimization, etc.) to train the best response action selection neural network, Π_{ϕ}, to maximize an expected return for the target agent.

The system can therefore train the best response neural network such that Π_{ϕ}(v*ᵢ) models a best response action selection policy (e.g., in terms of optimizing an expected return for the target agent) for the target agent when the other agents of the agent population are controlled using the population action selection neural network as conditioned on marginal strategy embeddings for the other agents (e.g., when the j-th agent is controlled following Π_{θ}(v̅_{¬i,j})).

In some implementations, the system can determine a distillation loss between the population action selection neural network and the best response action selection neural network (step 708). The distillation loss can be a divergence between action selection probabilities of the policies determined by the population action selection neural network and the best response action selection neural network. For example, when the i-th agent of the agent population is the target agent during the T-th update iteration for the population action selection neural network, the distillation loss can be the Kullback-Leibler divergence:

$${D}_{KL} ( {\prod }_{θ} ( \cdot \vert {v}_{i}^{T} ) ‖ {\prod }_{ϕ} ( \cdot \vert {v}_{i}^{*} ) )$$

As determined based on the generated trajectories, where Π_{θ} is the population action selection neural network, Π_{ϕ} is the best response action selection neural network, vᵢ^{T} is the T-th strategy embedding of the target agent for the population action selection neural network, and v*ᵢ is a strategy embedding for the target agent.

In some implementations, the system can determine a regularization loss between the population action selection neural network and a baseline population action selection neural network (step 710). The regularization loss can help prevent the population action selection neural network from catastrophically forgetting previously learned policies by encouraging the population action selection neural network to replicate policies from the baseline population action selection neural network. The baseline population action selection neural network can be a static, lagging copy of the population action selection neural network. For example, the baseline population action selection neural network can be a copy of the population action selection neural network from the start of the current update iteration or from a previous update iteration. As a further example, the baseline population action selection neural network can control the j-th agent of the agent population following Π_{\hat{θ}}(\hat{v}ⱼ), where \hat{θ} is a copy of previous population action selection neural network parameters and \hat{v}ⱼ is a copy of a previous strategy embedding for the j-th agent.

The regularization loss can be determined based on divergences between action selection probabilities of the policies determined by the population action selection neural network and the baseline population action selection neural network. For example, when the i-th agent of the agent population is the target agent during the T-th update iteration for the population action selection neural network, the regularization loss can be a sum of the Kullback-Leibler divergences:

$${D}_{KL} ( {\prod }_{θ} ( \cdot \vert {v}_{j}^{T} ) ‖ {\prod }_{\hat{θ}} ( \cdot \vert {\hat{v}}_{j} ) )$$

For each of the non-target agents, where Π_{θ} is the population action selection neural network, Π_{\hat{θ}} is the baseline population action selection neural network, vⱼ^{T} is the T-th strategy embedding of the j-th agent for the population action selection neural network, and \hat{v}ⱼ is a copy of a previous strategy embedding for the j-th agent.

The system can train the population action selection neural network based on the plurality of trajectories (step 712). When the system determines a distillation loss over the generated trajectories, the system can optimize the distillation loss as part of training the population action selection neural network. When the system determines a regularization loss over the generated trajectories, the system can optimize the regularization loss as part of training the population action selection neural network. The system can train the population action selection neural network using any appropriate reinforcement learning technique (e.g., policy gradients, proximal policy optimization, etc.)

As part of training the population action selection neural network, the system can train the strategy embeddings for the population action selection neural network. For example, during the T-th update iteration, when the system determines a distillation loss, the system can train the T-th strategy embedding for the target agent (e.g., vᵢ^{T}) by backpropagating gradients of the distillation loss through the population action selection neural network and into the strategy embedding.

The training system can use the processes 600 and 700 described above to train the population action selection system to select policies for multiple (e.g., two or more) agents interacting with each other and an environment. In some implementations, e.g., when the action selection policies select actions for agents interacting in a two-player game, the training system can use an alternative process to train the population action selection system based on interactions between pairs of agents.

FIG. 8 is a flow diagram of an example process for training a population action selection system based on interactions between pairs of agents. For convenience, the process 800 will be described as being performed by a system of one or more computers located in one or more locations. For example, a training system, e.g., the training system 502 of FIG. 5, appropriately programmed in accordance with this specification, can perform the process 800.

The training system can train the population action selection system over a sequence of update iterations. The training system can train the population action selection system to select actions for each of a pair of agents jointly interacting within an environment to perform a respective task. As a particular example, the population action selection system can select actions for a pair of agents interacting as part of a competitive game between the two agents.

The training system can train the population action selection system to learn a set of action selection policies that can be shared between the agents. As described above, the population action selection system can select actions for an agent according to a particular action selection policy by conditionally processing a strategy embedding specific to the action selection policy. For example, the population action selection system can select actions according to action selection policy a by conditionally processing a strategy embedding, vₐ, that is specific to the policy a. The training system can train the population action selection system by optimizing both the neural network parameters of the population action selection system and the strategy embeddings for the action selection policies.

In general, the training system can train the population action selection system to optimize action selection policies represented by a set of N strategy embeddings, v₁ . . . v_{N}, by optimizing how each of the strategy embeddings performs when paired against other strategy embeddings of the set.

In some implementations, the system can determine a payoff matrix that calculates expected payoffs between pairs of the action selection policies (step 802). Each payoff value within the payoff matrix can characterizes an expected return achieved by controlling one agent of the pair using a first action selection policy while controlling the other agent of the pair using a second action selection policy. As an example, the payoff matrix can include the payoff values, EP_{i,j}, denoting a payoff expected by an agent using the i-th action selection policy when facing another agent using the j-th action selection policy. As a further example, the payoff matrix can be determined by a pair-wise function of strategy embeddings, following:

$${EP}_{i , j} = EP ( {v}_{i} , {v}_{j} )$$

The system can determine the payoff values by any appropriate method. For example, the system can generate trajectories that characterize interactions between pairs of agents to determine the payoff values. For example, the system can generate one or more trajectories that characterizing controlling the first agent of the pair using the i-th strategy embedding, vᵢ, and controlling the second agent of the pair using the j-th strategy embedding, vⱼ and can determine the payoff value EP_{i,j} based on returns received by the first agent of the pair interacting with the second agent of the pair. As a particular example, the payoff value, EP_{i,j}, can be an average of the returns received by the first agent as a result of interacting with the second agent of the pair.

As another example, the system can model the payoff matrix using a payoff prediction model, ϕ_{ω}, that can predict payoff values by processing inputs that identify pairs of action selection policies. For example, the system can determine the payoff value EP_{i,j} following:

$${EP}_{i , j} = {ϕ}_{ω} ( {v}_{i} , {v}_{j} )$$

The system can train the payoff prediction model by minimizing an expected error between predictions from the payoff prediction model and target values. For example, the expected error can be an expectation of an error, Δ, over a state visitation distribution, p_{i,j} (e.g., a distribution that determines a probability of each policy being used to control agents of the pair) following:

$$L = {E}_{{v}_{i} , {v}_{j} ∼ {p}_{i , j}} [ Δ ( {ϕ}_{ω} ( {v}_{i} , {v}_{j} ) , Q ( {v}_{i} , {v}_{j} ) ) ]$$

Where Q(vᵢ, vⱼ) is a state value (e.g., an actual received return) of the environment when the first agent is controlled using the i-th action selection policy, vᵢ, and the second agent is controlled using the j-th action selection policy, vⱼ. The error, Δ, can be any suitable error (e.g., mean squared error, ridge regression loss, etc.).

For each update iteration, the system can determine a probability distribution that defines interaction probabilities between pairs of the action selection policies (step 804). The system can use the interaction probabilities to determine which action selection policies to pair together when training the population action selection neural network.

For example, the system can determine an interaction probability matrix, Σ, that includes interaction probabilities for each pairing of action selection policies. As a further example, system can use the interaction probability, Σ_{i,j}, as the probability that the system pairs the i-th action selection policy, vᵢ, with the j-th action selection policy, vⱼ, when the system trains the i-th action selection policy, vᵢ.

As an example, the system can determine the probability distribution by obtaining a predefined probability distribution for each action selection policy. As one example, the pre-defined distribution can be a population self-play distribution, for which

$${\sum }_{i , j} = \frac{1}{N} .$$

As another example, the pre-defined distribution can be a fictitious play distribution, in which

$${\sum }_{i , j} = \frac{1}{i}$$

for j≤i and Σ_{i,j}=0 for j>i.

As another example, when the system determines the payoff matrix, the system can determine the probability distribution based on the payoff matrix. In particular, the system can determine the probability distribution to be an equilibrium solution (e.g., a Nash equilibrium, a correlated equilibrium, an ε-coarse correlated equilibrium, etc.) for the payoff matrix. The system can determine the probability distribution by processing the payoff matrix using any appropriate meta-graph solver. For example, the system can determine the probability distribution using an LP Nash solver as described by Shoham and Leyton-Brown in “Multiagent Systems: Algorithmic, Game-Theoretic, and Logical Foundations” (2008). As another example, the system can determine the probability distribution using an ε-CCE solver, such as a Max-Gini ε-CCE solver as described by Marris et al. in “Multi-Agent Training Beyond Zero-Sum with Correlated Equilibrium Meta-Solvers” (2021).

The system can restrict the probability distribution to form a lower-triangular matrix. For example, the system can restrict Σ such that Σ_{i,j}=0 for j>i. When the system restricts the probability distribution to form a lower-triangular matrix, the system can train each action selection policy as paired with a particular restricted set of previous policies.

The system can generate trajectories for the update iteration by selecting pairs of action selection policies according to the probability distribution (step 806). The system can generate trajectories for each of the action selection policies using the policy to control the first agent and by selecting a policy to control the second agent according to the probability distribution for the update iteration. For example, the system can generate a trajectory for the i-th action selection policy, vᵢ, by controlling the first agent using vᵢ and by selecting the j-th action selection policy, vⱼ, to control the second agent with probability Σ_{i,j}. The system can determine rewards or returns received by the first agent as a result of interacting with the second agent as part of generating the trajectories.

The system can then train the population action selection neural network using the generated trajectories (step 808). In particular, the system can train the action selection neural network for each of the action selection policies using the trajectories for the policy (e.g., the trajectories generated by using the policy to control the first agent). As an example, the system can train the population action selection neural network to maximize an expected return or reward for an agent controlled using the i-th action selection policy, vᵢ, as interacting with another agent controlled using the j-th action selection policy, vⱼ, with probability Σ_{i,j}.

The system can use any of a variety of reinforcement learning techniques to train the population action selection neural network based on the received returns or rewards for the trajectories (e.g., Q-learning, policy gradients, proximal policy optimization, etc.).

As part of training the population action selection neural network, the training system can train and update the strategy embeddings, v₁ . . . v_{N}. For example, the system can backpropagate gradients through the population action selection neural network and into the strategy embeddings representing the action selection policies to train the strategy embeddings v₁ . . . v_{N}.

The system can determine whether the training has completed (step 810). The system can determine whether the training has completed based on any suitable criterion. For example, the system can determine that training has completed after a pre-determined number of update iterations. As another example, the system can determine that training has completed based on the set of payoff values for the update iteration. As a particular example, the system can determine that training has completed based on whether the payoff values for the update iteration attain pre-determined threshold values. As another particular example, the system can determine that training has completed based on a difference between the payoff values for the current update iteration and a previous update iteration (e.g., based on whether the difference indicates a convergence of the population action selection neural network).

If the system determines that training has not completed, the system can proceed to a next update iteration for training the population action selection neural network.

When the system determines that the training has completed, the system can return the trained population action selection neural network (step 812).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
controlling an agent interacting with an environment using a population of action selection policies that are jointly represented by a population action selection neural network, comprising, at each of a plurality of time steps:
obtaining an observation characterizing a current state of the environment at the time step;
selecting a target action selection policy from the population of action selection policies;
processing a network input comprising: (i) the observation, and (ii) a strategy embedding representing the target action selection policy, using the population action selection neural network to generate an action selection output; and
selecting an action to be performed by the agent at the time step using the action selection output.

2. The method of claim 1, wherein the agent is one agent in a collection of agents, wherein the population of action selection policies comprises, for each agent in the collection of agents, a set of action selection policies for the agent that each define a respective policy for selecting actions to be performed by the agent to interact with the environment; and
wherein the population action selection neural network has been trained by operations comprising, at each of a plurality of update iterations:
determining a set of payoff values, wherein each payoff value characterizes a return received as a result of controlling each agent using a respective action selection policy for the agent;
processing the set of payoff values to generate a probability distribution over a strategy assignment space, wherein each point in the strategy assignment space represents an assignment of a respective action selection policy to each agent in the collection of agents; and
training the population action selection neural network based on the probability distribution over the strategy assignment space.

3. The method of claim 2, wherein training the population action selection neural network based on the probability distribution over the strategy assignment space comprises, for a target agent:
selecting one or more points from the strategy assignment space using the probability distribution over the strategy assignment space;
generating an aggregate strategy assignment embedding of the points selected from the strategy assignment space;
generating a plurality of trajectories representing interaction of the collection of agents with the environment as the target agent is controlled by an action selection policy associated with the aggregate strategy assignment embedding; and
training the population action selection neural network based on the plurality of trajectories.

4. The method of claim 3, wherein selecting one or more points from the strategy assignment space using the probability distribution over the strategy assignment space comprises:
selecting one or more points in the strategy assignment space having highest probabilities under the probability distribution over the strategy assignment space.

5. The method of claim 3, wherein selecting one or more points from the strategy assignment space using the probability distribution over the strategy assignment space comprises:
sampling one or more points from the strategy assignment space in accordance with the probability distribution over the strategy assignment space.

6. The method of claim 3, wherein generating the aggregate strategy assignment embedding of the points selected from the strategy assignment space comprises:
determining, for each of the points selected from the strategy assignment space, a respective strategy assignment embedding for the point based on the respective strategy embedding of each action selection policy specified by the point in the strategy assignment space other than the action selection policy specified for the target agent; and
generating the aggregate strategy assignment embedding based on the respective strategy assignment embedding for each of the points selected from the strategy assignment space.

7. The method of claim 6, wherein generating the aggregate strategy assignment embedding based on the respective strategy assignment embedding for each of the points selected from the strategy assignment space comprises:
generating the aggregate strategy assignment embedding as a linear combination of the respective strategy assignment embedding for each of the points selected from the strategy assignment space,
wherein for each of the points selected from the strategy assignment space, the strategy assignment embedding for the point is scaled by a probability of the point under the probability distribution over the strategy assignment space.

8. The method of claim 3, wherein the action selection policy associated with the aggregate strategy assignment embedding is implemented by a best response action selection neural network that is conditioned on the aggregate strategy assignment embedding.

9. The method of claim 8, wherein the best response action selection neural network is configured to, when conditioned on the aggregate strategy assignment embedding:
receive an observation characterizing a state of the environment; and
process the observation and the aggregate strategy assignment embedding, in accordance with values of a set of neural network parameters, to generate an action selection output that characterizes an action to be performed by a corresponding agent in response to the observation.

10. The method of claim 8, wherein training the population action selection neural network based on the plurality of trajectories comprises:
conditioning the best response action selection neural network on the aggregate strategy assignment embedding;
training the best response action selection neural network on the plurality of trajectories using a reinforcement learning technique; and
training the population action selection neural network using the best response action selection neural network.

11. The method of claim 10, wherein training the population action selection neural network using the best response action selection neural network comprises:
conditioning the population action selection neural network on a strategy embedding corresponding to an action selection policy of the target agent;
training the population action selection neural network to optimize a distillation loss that measures an error between: (i) action selection outputs generated by the population action selection neural network, and (ii) action selection outputs generated by the best response action selection neural network.

12. The method of claim 11, wherein training the population action selection neural network to optimize the distillation loss further comprises:
training the strategy embedding corresponding to the action selection policy of the target agent, comprising backpropagating gradients of the distillation loss through the population action selection neural network and into the strategy embedding corresponding to the action selection policy of the target agent.

13. The method of claim 3, wherein generating the plurality of trajectories representing interaction of the collection of agents with the environment as the target agent is controlled by the action selection policy associated with the aggregate strategy assignment embedding comprises:
controlling each agent other than the target agent using the population action selection neural network.

14. The method of claim 3, wherein training the population action selection neural network based on the plurality of trajectories further comprises:
training the population action selection neural network to optimize a regularization loss that measures an error between: (i) action selection outputs generated by the population action selection neural network by processing observations from the trajectories, and (ii) action selection outputs generated by a baseline population action selection neural network by processing observations from the trajectories;
wherein the baseline population action selection neural network is a static, lagging copy of the population action selection neural network.

15. The method of claim 2, wherein determining the set of payoff values comprises, for each payoff value:
processing an input that identifies a respective action selection policy for each agent in the collection of agents using a payoff prediction model to generate a predicted return that is predicted to result from controlling each agent using the corresponding action selection policy.

16. The method of claim 2, further comprising:
determining that a termination criterion for the update iteration is not satisfied, comprising:
determining, for each of multiple strategy assignments, a delta between: (i) a current payoff value for the strategy assignment, and (ii) a previous payoff value for the strategy assignment, wherein each strategy assignment assigns a respective action selection policy to each agent in the collection of agents; and
determining that the termination criterion for the update iteration is not satisfied based on the deltas;
in response, further training the population action selection neural network before starting a next update iteration.

17. A system comprising:
one or more computers; and
one or more storage devices communicatively coupled to the one or more computers, wherein the one or more storage devices store instructions that, when executed by the one or more computers, cause the one or more computers to perform operations, the operations comprising:
controlling an agent interacting with an environment using a population of action selection policies that are jointly represented by a population action selection neural network, comprising, at each of a plurality of time steps:
obtaining an observation characterizing a current state of the environment at the time step;
selecting a target action selection policy from the population of action selection policies;
processing a network input comprising: (i) the observation, and (ii) a strategy embedding representing the target action selection policy, using the population action selection neural network to generate an action selection output; and
selecting an action to be performed by the agent at the time step using the action selection output.

18. One or more non-transitory computer storage media storing instructions that when executed by one or more computers cause the one or more computers to perform operations, the operations comprising:
controlling an agent interacting with an environment using a population of action selection policies that are jointly represented by a population action selection neural network, comprising, at each of a plurality of time steps:
obtaining an observation characterizing a current state of the environment at the time step;
selecting a target action selection policy from the population of action selection policies;
processing a network input comprising: (i) the observation, and (ii) a strategy embedding representing the target action selection policy, using the population action selection neural network to generate an action selection output; and
selecting an action to be performed by the agent at the time step using the action selection output.

19. The one or more non-transitory computer storage media of claim 18, wherein the agent is one agent in a collection of agents, wherein the population of action selection policies comprises, for each agent in the collection of agents, a set of action selection policies for the agent that each define a respective policy for selecting actions to be performed by the agent to interact with the environment; and
wherein the population action selection neural network has been trained by operations comprising, at each of a plurality of update iterations:
determining a set of payoff values, wherein each payoff value characterizes a return received as a result of controlling each agent using a respective action selection policy for the agent;
processing the set of payoff values to generate a probability distribution over a strategy assignment space, wherein each point in the strategy assignment space represents an assignment of a respective action selection policy to each agent in the collection of agents; and
training the population action selection neural network based on the probability distribution over the strategy assignment space.

20. The one or more non-transitory computer storage media of claim 19, wherein training the population action selection neural network based on the probability distribution over the strategy assignment space comprises, for a target agent:
selecting one or more points from the strategy assignment space using the probability distribution over the strategy assignment space;
generating an aggregate strategy assignment embedding of the points selected from the strategy assignment space;
generating a plurality of trajectories representing interaction of the collection of agents with the environment as the target agent is controlled by an action selection policy associated with the aggregate strategy assignment embedding; and
training the population action selection neural network based on the plurality of trajectories.
